(19) United States
(12) Patent Application Publication
(10) Pub. No.: US 2020/0220960 A1
(43) Pub. Date: Jul. 9, 2020

(54) SELF-TIMER MECHANISM WITH ADJUSTABLE ACCOMMODATING POSITION

(71) Applicant: Shenzhen Jindu Technology Co., Ltd., Shenzhen City (CN)

(72) Inventor: Jianqing LIU, Shenzhen City (CN)

(21) Appl. No.: 16/243,465

(22) Filed: Jan. 9, 2019

(51) Int. Cl. H04M 1/04; F16M 11/26

(52) U.S. Cl. CPC H04M 1/04; F16M 11/26

(57) ABSTRACT

The present invention discloses a self-timer mechanism with adjustable accommodating position, comprising a telescopic rod and a fixing bracket connected with the telescopic rod. The fixing bracket comprises a bracket body, and the bracket body is provided with a transverse stretching rod, and the transverse stretching rod is arranged with a first clamping member, and the transverse stretching rod can be laterally extended and retracted relative to the bracket body, so that the first clamping member and the bracket body form a laterally adjustable position for accommodating the mobile power source. The bracket body is further provided with a longitudinal stretching rod having second clamping member combining with the bracket body to form a longitudinal adjustable position for accommodating the photographing device. The adjustable position greatly expands the use range of the photographing device of the present invention, and can meet various needs.

### FIELD OF THE INVENTION

The invention relates to the technical field of photographic equipment, in particular to a self-timer mechanism with adjustable accommodating position.

### BACKGROUND OF THE INVENTION

With the advancement of science and technology and the development of the economy and society, smart phones have been widely used in our daily lives, and the pixels of mobile phones are getting higher and higher, and the camera functions are becoming more and more powerful, which has a tendency to replace the traditional camera. However, currently taking a photo with a mobile phone still has certain limitations. If you use a hand-held camera provided on the mobile phone, the handheld distance will greatly limit the range of the camera, and the hand-held camera will be easy to shake, which will affect the quality of the photo. If you use a tripod-like fixture to take pictures, it will be inconvenient because of the large size and weight of the tripod. In order to solve the above problems, various types of self-timer rods have appeared on the market, but most of the existing self-timer rods still cause inconvenience in use, for example, due to the small battery life of existing photographing devices, it can't take photos for a long time.

### SUMMARY OF THE INVENTION

In order to overcome the deficiencies of the prior art, the present invention provides a self-timer mechanism with adjustable accommodating position.

The technical solution adopted by the present invention to solve the technical problem thereof is:

A self-timer mechanism with adjustable accommodating position, including:

a telescopic rod;

a fixing bracket connected to the telescopic rod, wherein, the fixing bracket includes a bracket body with a transverse stretching rod, and a first holding part is mounted on the transverse stretching rod;

wherein, the transverse stretching rod can be laterally extended and retracted relative to the bracket body, so that the first clamping member and the bracket body form a laterally adjustable position for accommodating a mobile power source.

Further, the bracket body is provided with a side wall having a longitudinal stretching rod, and the longitudinal stretching rod is mounted with a second clamping member, and the longitudinal stretching rod can be longitudinally extended and retracted relative to the bracket body, so that the second clamping member and the bracket body form a longitudinally adjustable position for accommodating a camera.

Further, the longitudinal stretching rod is provided with two on the left and right sides, and the side wall is composed of two sleeves respectively corresponding to the left and right longitudinal stretching rods.

Further, the transverse stretching rod is provided with two on the left and right sides, and the bracket body is provided with two other sleeves for accommodating the left and right transverse stretching rods respectively, and the left and right longitudinal stretching rods and the left and right transverse stretching rods are arranged vertically.

Further, the fixing bracket is connected to the telescopic rod by a circular rotating shaft.

Further, the telescopic rod comprises an inner shrink tube and an outer protective sleeve, and the inner shrink tube is made of metal material.

Further, the outer protective sleeve is a cylindrical frosted rubber sleeve.

Further, the upper part of the telescopic rod is provided with a transparent button, and the outer contour of the transparent button adopts an arc shape matching the outer surface of the telescopic rod.

In addition, the telescopic rod has a telescopic range of 20-50 CM.

The present invention has the beneficial effects that:

The invention discloses a new self-timer rod, on the one hand, since the fixing bracket comprises a bracket body having a transverse stretching rod mounted with a first clamping member, and the transverse stretching rod can be laterally stretched and contracted with respect to the bracket body, so that the first clamping member and the bracket body form a laterally adjustable position for accommodating a mobile power source. The mobile power source can be installed for long time shooting, and can also be given to charge some digital products when not shooting. On the other hand, the bracket body is provided with a longitudinal stretching rod mounted with a second clamping member, and the longitudinal stretching rod can be longitudinally extended and retracted relative to the bracket body, so that the second clamping member and the bracket body form an adjustable position for accommodating a camera. The adjustable accommodating position greatly expands the use range of the photographing device of the present invention, which can meet various needs, and greatly improves versatility.

### BRIEF DESCRIPTION OF THE DRAWINGS

The present invention will be further described below in conjunction with the accompanying drawings and embodiments:

FIG. 1 is a first schematic view of a three-dimensional structure of the present invention;

FIG. 2 is a second schematic view of the three-dimensional structure of the present invention;

FIG. 3 is a third perspective view of the three-dimensional structure of the present invention;

FIG. 4 is a fourth perspective view of the three-dimensional structure of the present invention;

FIG. 5 is a schematic view of the explosion structure of the present invention;

FIG. 6 is a first side view of the working state of one embodiment according to the present invention, wherein, the longitudinal stretching rod and the transverse stretching rod are both in a contracted state;

FIG. 7 is a second side view of the working state of one embodiment according to the present invention, wherein, the longitudinal stretching rod and the transverse stretching rod are both in a stretched state.

### DETAILED DESCRIPTION OF THE EMBODIMENTS

The design scheme of the present invention to achieve the above objectives is:

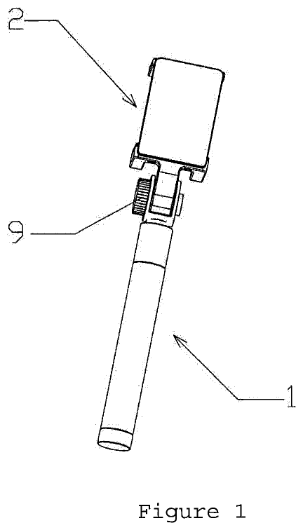

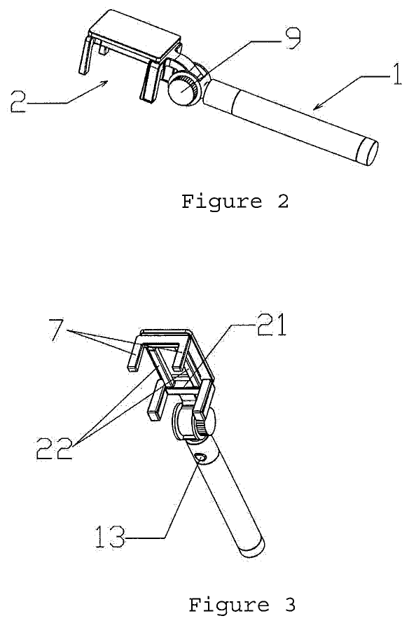

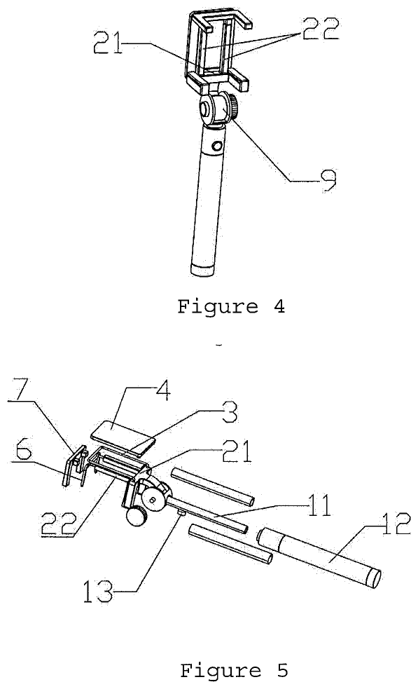

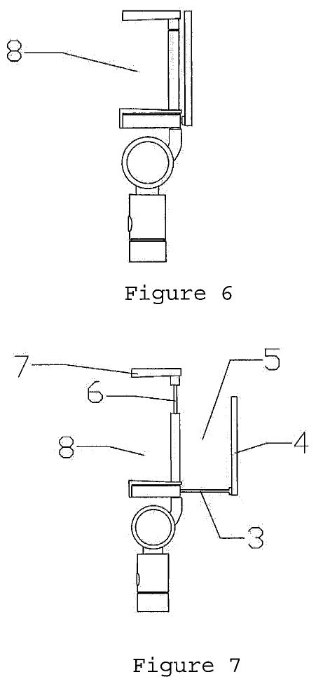

Referring to FIGS. 1 to 7, a self-timer rod includes a telescopic rod 1 and a fixing bracket 2 connected to the telescopic rod 1. The fixing bracket 2 includes a bracket body 21, and the bracket body 21 is provided with a transverse stretching rod 3 on which a first clamping member 4 is mounted, the transverse stretching rod 3 being laterally expandable and contractable relative to the bracket body 21, so that the first clamping member 4 and the bracket body 21 form a laterally adjustable position 5 for accommodating a mobile power source. The adjustable position 5 can be installed with a mobile power source for long time shooting, and can also charge some digital products when not shooting.

The bracket body 21 is provided with a side wall 22, and the side wall 22 is provided with a longitudinal stretching rod 6, on which a second clamping member 7 is mounted, and the longitudinal stretching rod 6 can be longitudinally stretched and contracted with respect to the bracket body 21, so that the second clamping member 7 and the bracket body 21 form a longitudinally adjustable position 8 for accommodating a camera. The longitudinal adjustable position 8 greatly expands the scope of use of the imaging device of the present invention, and can meet various needs.

The longitudinal stretching rod 6 is provided with two on the left and right sides, and the side wall 22 is composed of two sleeves respectively corresponding to the left and right longitudinal stretching rods 6, which are made of plastic or rubber, in order to protect the longitudinal stretching rod 6.

The transverse stretching rods 3 are provided with two on the left and right sides, and the bracket body 21 is provided with two other sleeves respectively corresponding to the left and right transverse stretching rods 3, and the left and right longitudinal stretching rods 6 and the two transverse stretching rods 3 are vertically arranged.

The fixing bracket 2 is connected to the telescopic rod 1 via a circular shaft 9, and the arrangement of the circular shaft 9 increases the convenience of the rotation angle of the telescopic rod 1 and the fixing bracket 2.

The telescopic rod 1 includes an inner shrink tube 11 and an outer protective sleeve 12, and the inner shrink tube 11 is made of a metal material. The outer protective sleeve 12 is a cylindrical frosted rubber sleeve. The frosted rubber sleeve can not only protects, but also increases friction, which in turn increases grip strength.

The upper portion of the telescopic rod 1 is provided with a color transparent button 13, and the outer contour of the colored transparent button 13 is curved in shape to match the outer surface of the telescopic rod 1. The color transparent button 13 preferably adopts conspicuous red, blue or green color, and the outer contour of the colored transparent button 13 adopts an arc shape matching the outer surface of the telescopic rod 1, which is not only beautiful but also convenient to use.

The preferred embodiments of the present invention have been described in detail above. Of course, the present invention may adopt different forms and similar fields from the above-described embodiments, and these do not constitute any limitation on the present embodiment, and equivalent transformations or corresponding modifications made by those skilled in the art without departing from the spirit of the invention should fall within the scope of the invention. Of course, the above embodiments are not limitations to the invention, and other equal technical schemes should be in the protection scope of the invention.

What is claimed is:

1. A self-timer mechanism with adjustable accommodating position, including:
a telescopic rod;
a fixing bracket connected to the telescopic rod, wherein, the fixing bracket includes a bracket body with a transverse stretching rod, and a first holding part is mounted on the transverse stretching rod;
wherein, the transverse stretching rod can be laterally extended and retracted relative to the bracket body, so that the first clamping member and the bracket body form a laterally adjustable position for accommodating a mobile power source.

2. The self-timer mechanism with adjustable accommodating position according to claim 1, wherein the bracket body is provided with a side wall having a longitudinal stretching rod, and the longitudinal stretching rod is mounted with a second clamping member, and the longitudinal stretching rod can be longitudinally extended and retracted relative to the bracket body, so that the second clamping member and the bracket body form a longitudinally adjustable position for accommodating a camera.

3. The self-timer mechanism with adjustable accommodating position according to claim 2, wherein the longitudinal stretching rod is provided with two on the left and right sides, and the side wall is composed of two sleeves respectively corresponding to the left and right longitudinal stretching rods.

4. The self-timer mechanism with adjustable accommodating position according to claim 3, wherein the transverse stretching rod is provided with two on the left and right sides, and the bracket body is provided with two other sleeves for accommodating the left and right transverse stretching rods respectively, and the left and right longitudinal stretching rods and the left and right transverse stretching rods are arranged vertically.

5. The self-timer mechanism with adjustable accommodating position according to claim 2, wherein the fixing bracket is connected to the telescopic rod by a circular rotating shaft.

6. The self-timer mechanism with adjustable accommodating position according to claim 1, wherein the telescopic rod comprises an inner shrink tube and an outer protective sleeve, and the inner shrink tube is made of metal material.

7. The self-timer mechanism with adjustable accommodating position according to claim 6, wherein the outer protective sleeve is a cylindrical frosted rubber sleeve.

8. The self-timer mechanism with adjustable accommodating position according to claim 1, wherein the upper part of the telescopic rod is provided with a transparent button, and the outer contour of the transparent button adopts an arc shape matching the outer surface of the telescopic rod.

9. The self-timer mechanism with adjustable accommodating position according to claim 8, wherein the telescopic rod has a telescopic range of 20-50 CM.
